(19) United States
(12) Patent Application Publication
(10) Pub. No.: US 2023/0038821 A1
(43) Pub. Date: Feb. 9, 2023

(54) OBJECT DETECTION SYSTEM AND OBJECT DETECTION METHOD

(71) Applicant: Mitsubishi Electric Corporation, Tokyo (JP)

(72) Inventor: Naoyuki TSUSHIMA, Tokyo (JP)

(73) Assignee: Mitsubishi Electric Corporation, Tokyo (JP)

(21) Appl. No.: 17/795,123

(22) PCT Filed: Mar. 30, 2020
(86) PCT No.: PCT/JP2020/014438

§ 371 Date: Jul. 25, 2022

(51) Int. Cl. G01S 7/41; G01S 13/931

(52) U.S. Cl. CPC G01S 7/414; G01S 7/412; G01S 13/931

(57) ABSTRACT

Provided are a representative point extraction circuitry that extracts a representative reflection point of a target a line segment setting circuitry that sets a plurality of detection line segments of the same length that extend from the representative reflection point and are arranged within the irradiation field at intervals about the representative reflection point as a center, a reflection point counter that counts a coordinate point indicating a reflection level higher than a second threshold value as a reflection point by using the second threshold value, and a reflection point determinator that determines a reflection point counted in the detection line segments to a top second place in which the number of reflection points is large, as a reflection point from the target.

### TECHNICAL FIELD

The present application relates to an object detection system and an object detection method.

### BACKGROUND ART

In an object detection system such as a millimeter wave radar that detects an object by an echo from the object, it is required to suppress false detection due to an unnecessary signal called a clutter that fluctuates in time and space, depending on an environment. Therefore, a technique called a constant false alarm rate (CFAR) is used in which a threshold value used for determining on whether to detect an object is obtained by averaging reception intensity of a surrounding region with respect to the region where determination on the presence or absence of the detection is to be performed (refer to, for example, Non-Patent Document 1).

### CITATION LIST

### Non-Patent Document

Non-Patent Document 1: “Knowledge Base” edited by Institute of Electronics, Information and Communication Engineers (https://www.ieice-hbkb.org/files/11/11gun_02hen_05.pdf), Group 11 (Social information system), Part 2 (Electronic navigation and Navigation system), Chapter 5: Basic and common technology (ver. 1/Apr. 15, 2011), 5-2: Principle of radar, 5-2-1: Detection technology (author: Tetsuro Kirimoto)

### SUMMARY OF INVENTION

### Problems to be Solved by Invention

The above-described method of calculating the threshold value by the averaging is effective for suppressing false detection in a system in which the size of an object to be detected (target) is sufficiently smaller than the resolution of the radar and the object is captured as a point. However, in a recent high-resolution radar capable of detecting a plurality of points with respect to a single target, detection of other reflection points is hindered due to part of reflection points having a high reflection intensity, and it is sometimes difficult to achieve the intrinsic performance. As a result, there is a problem in that the shape of the target necessary for estimating the type of the object cannot be determined.

It is an object of the present application to disclose a technique for solving the above-mentioned problem, and to provide an object detection system and an object detection method capable of determining a shape of a target.

### Means for Solving Problems

An object detection system disclosed in the present application includes a wave device to radiate a wave and a receive reflected wave, a reflection level calculation unit to calculate a reflection level for each of coordinate points within an irradiation field from a signal output from the wave device, a representative point extraction unit to extract a coordinate point indicating a reflection level higher than a threshold value as a representative reflection point of an object that exists within the irradiation field by comparing a reflection level for each of the coordinate points with the threshold value set by using a first setting reference, a line segment setting unit to set a plurality of line segments of the same length that extend from the representative reflection point and are arranged at intervals in a circumferential direction within the irradiation field about the representative reflection point as a center, a reflection point counting unit to count a coordinate point indicating a reflection level higher than a second threshold value as a reflection point in each of the plurality of line segments by using the second threshold value set using a second setting reference by which a value lower than the threshold value is calculated, and a reflection point determination unit to determine a reflection point counted in the line segments to a top second place in which the number of the counted reflection points is large among the plurality of line segments, as a reflection point from the object.

An object detection method disclosed in the present application includes an object detection method, comprising, a reflection level calculation step of receiving a reflected wave when a wave is radiated and calculating a reflection level for each of coordinate points within an irradiation field, a representative point extraction step of extracting a coordinate point indicating a reflection level higher than the threshold value as a representative reflection point of an object that exists within the irradiation field by comparing a reflection level for each of the coordinate points with the threshold value set using a first setting reference, a line segment setting step of setting a plurality of line segments of the same length that extend from the representative reflection point and are arranged at the intervals in a circumferential direction within the irradiation field about the representative reflection point as a center, a reflection point counting step of counting a coordinate point indicating a reflection level higher than a second threshold value as a reflection point in each of the plurality of line segments by using the second threshold value set using a second setting reference by which a value lower than the threshold value is calculated, and a reflection point determination step of determining a reflection point counted in the line segments to the top second place in which the number of the counted reflection points is large among the plurality of line segments, as a reflection point from the object.

### Effect of Invention

According to the object detection system or the object detection method disclosed in the present application, the shape of the target can be determined by detecting arrangement of the reflection points.

### BRIEF DESCRIPTION OF DRAWINGS

FIG. 1A and FIG. 1B are a block diagram showing an overall configuration of an object detection system and a block diagram showing a detailed configuration of part of an analysis device for determining a shape of a target, respectively, according to Embodiment 1.

FIG. 2A and FIG. 2B are a flowchart showing an operation of a target reflection level receiving unit and a flowchart showing an operation of a target detection unit, respectively, for explaining an operation of the object detection system or an object detection method according to Embodiment 1.

FIG. 3 is a schematic diagram for explaining rotation of a detection line segment for a detection determination in a stepwise manner around a reference point in the operation of the object detection system or the object detection method according to Embodiment 1.

FIG. 4A and FIG. 4B are schematic diagrams for explaining a setting of a threshold value in a certain detection line segment for performing the detection determination and a graphical diagram for explaining a setting of the threshold value in accordance with signal intensity on a certain detection line segment, respectively, in the operation of the object detection system or the object detection method according to Embodiment 1.

FIG. 5A and FIG. 5B are schematic diagrams for explaining the number of reflection points detected for each detection line segment and a selection of the detection line segments as the shape of the object when a position of each of the targets is different, in the operation of the object detection system or the object detection method according to Embodiment 1.

FIG. 6 is a block diagram showing an overall configuration of an object detection system according to Embodiment 2.

FIG. 7 is a block diagram showing an overall configuration of an object detection system according to Embodiment 3.

FIG. 8 is a block diagram showing a detailed configuration of part of an analysis device for determining a shape of a target in an object detection system according to Embodiment 3.

FIG. 9A and FIG. 9B are a flowchart showing an operation of a target reflection level receiving unit and a flowchart showing an operation of a target detection unit, respectively, for explaining an operation of an object detection system or an object detection method, according to Embodiment 3.

FIG. 10 is a block diagram showing an example of a hardware configuration of the analysis device according to each embodiment 1.

### MODES FOR CARRYING OUT INVENTION

### Embodiment 1

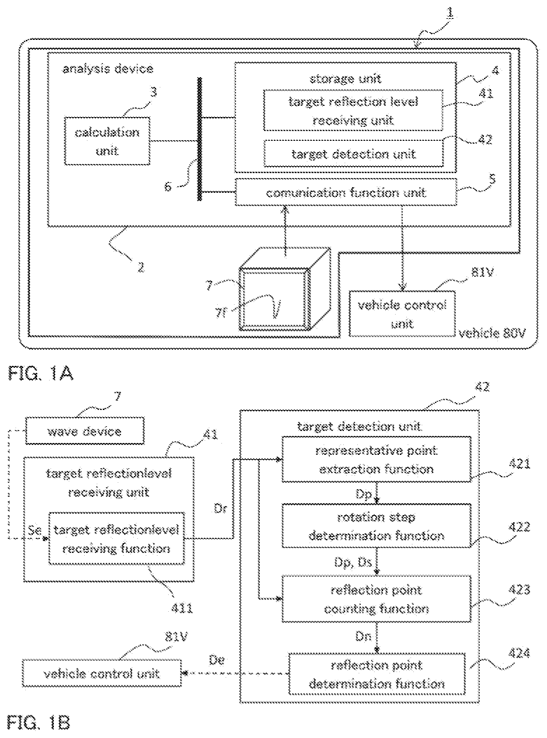

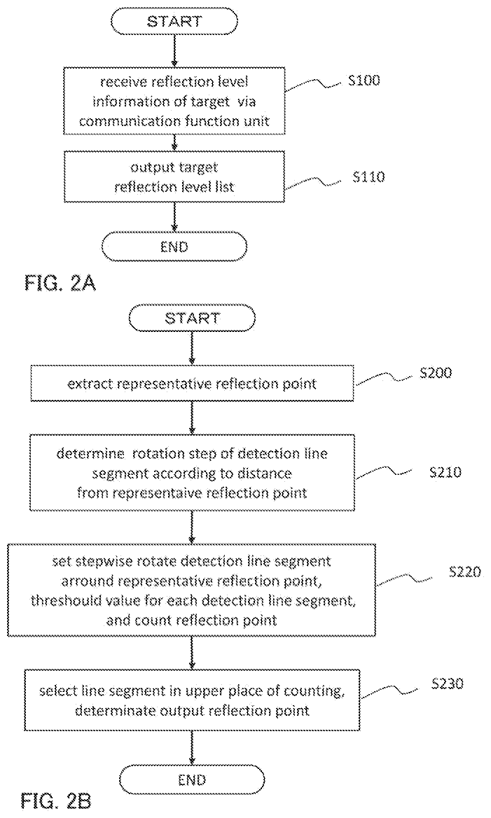

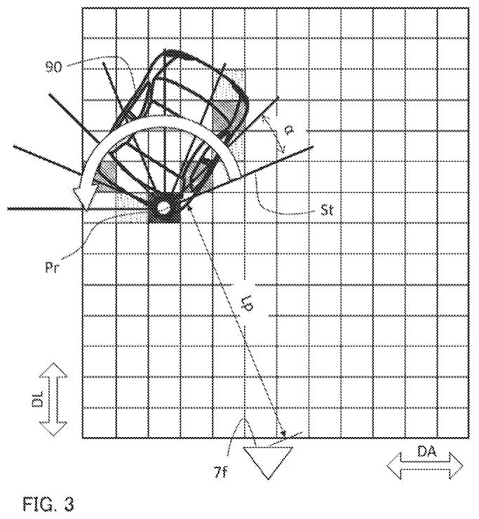

FIG. 1 to FIG. 5 are diagrams for explaining an object detection system or an object detection method according to Embodiment 1, FIG. 1 includes a block diagram showing an overall configuration of the object detection system (FIG. 1A) and a block diagram showing a detailed configuration of part of an analysis device for determining a shape of a target (FIG. 2A), and FIG. 2 includes a flowchart showing an operation of a target reflection level receiving unit (FIG. 2A) and a flowchart showing an operation of a target detection unit (FIG. 2B). FIG. 3 is a schematic diagram showing a signal intensity for each coordinate detected in a case where one target exists within an irradiation field when waves of a radar are radiated in the horizontal direction and a method for rotating a detection line segment for a target detection in a stepwise manner within an irradiation field (in a plane) around a reference point in accordance with the signal intensity obtained.

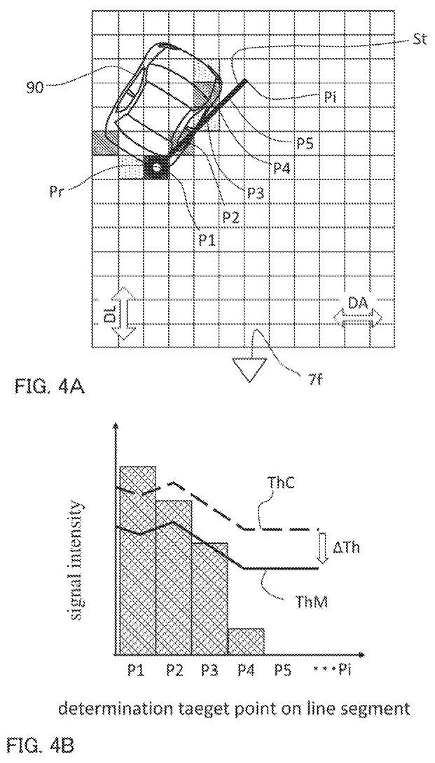

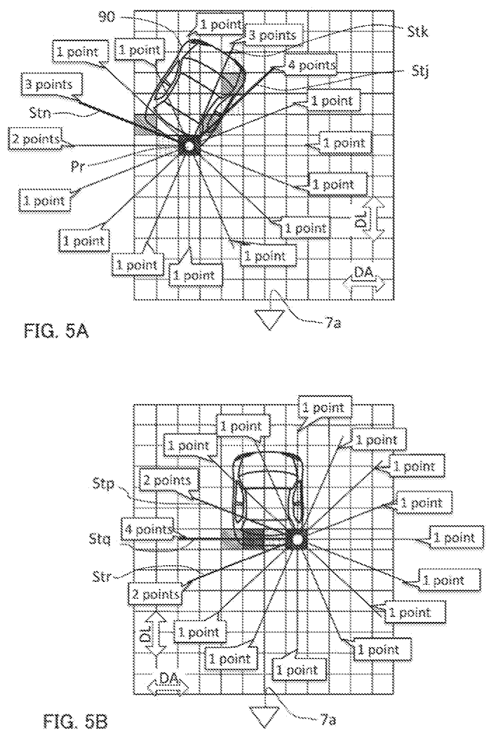

FIG. 4 includes a schematic diagram (FIG. 4A) corresponding to FIG. 3 for explaining a setting of a threshold value on a certain detection line segment among a plurality of detection line segments of the rotational movement for performing detection determination, and a diagram (FIG. 4B) in a bar graph for explaining signal intensity at each of a plurality of determination target points on a certain detection line segment and a method for setting two kinds of threshold values based on different references. Further, FIG. 5 is a diagram for explaining the number of detection of the reflection points in each of the plurality of detection line segments set at intervals about a representative reflection point as a center and a selection of the detection line segments as the shape of the target, and includes a schematic diagram (FIG. 5A) corresponding to FIG. 3 in the case where a vehicle as the target exists in an inclined state at a left front area and a schematic diagram (FIG. 5B) corresponding to FIG. 3 in the case where the vehicle as the target exists in a straight state at a front center area.

As shown in FIG. 1A, the object detection system 1 according to Embodiment 1 of the present application is provided with a wave device 7 that radiates a wave and receives a reflected wave from the target, and an analysis device 2 that analyzes a position and distance of the target on the basis of a signal from the wave device 7 and is installed in a vehicle 80V. When the wave device 7 is installed (mounted) in the vehicle 80V, for example, a preceding vehicle, an oncoming vehicle, a crossing pedestrian, and other obstacles are detected as targets, and the information is output to a vehicle control unit 81V for use in driving assistance and the like.

It is assumed that the wave device 7 is a radar device having a transmission/reception face 7f for receiving a reflected wave reflected by a target by radiating a radio wave such as a millimeter wave as a wave in a predetermined angle range in a horizontal direction, for example. However, it is not limited to this. As long as the reflected wave from the target can be received, other sensors other than that using the radio wave may be used, for example, a light detection and ranging system (LIDAR) using light or an ultrasonic sensor using sound waves may be used.

The analysis device 2 is provided with a calculation unit 3 for executing analysis processing, a storage unit 4 for storing calculation functions and the like of the calculation unit 3, a communication function unit 5 for exchanging data between the wave device 7 and the vehicle control unit 81V, and a bus 6 for connecting the calculation unit 3, the storage unit 4, and the communication function unit 5 so as to be able to communicate bidirectionally.

The communication function unit 5 is connected to the wave device 7 and the vehicle control unit 81V via a signal line (not shown).

The calculation unit 3 is constituted by an arithmetic unit such as a microcomputer or a digital signal processor (DSP), and the arithmetic unit 3 and the storage unit 4 in the analysis device 2, for example, can be constituted by one piece of hardware in which the arithmetic unit (processor) and a storage device are combined. In this case, the storage unit 4 (storage device) includes a volatile storage device such as a random access memory and a non-volatile auxiliary storage device such as a flash memory, which are not shown.

Further, an auxiliary storage device of a hard disk may be provided in place of the flash memory. The calculation unit 3 (processor) executes a program input from a storage device. In this case, the program is input from the auxiliary storage device to the processor via the volatile storage device.

Further, the processor may output data such as calculation results to the volatile storage device of the storage device or may store the data in the auxiliary storage device via the volatile storage device.

As shown in FIG. 1B, a target reflection level receiving function 411 among the functions stored in the storage unit 4 receives a signal Se output from the wave device 7 and causes the calculation unit 3 to function as a target reflection level receiving unit 41 that outputs a reflection level (reflection level list Dr) for each coordinate. Then, the representative point extraction function 421 or the like detects the target from the reflection level list Dr and causes the calculation unit 3 to function as a target detection unit 42 that outputs object detection information De such as a distance, a position, and a contour shape to the vehicle control unit 81V.

The target detection unit 42 includes a representative point extraction function 421 for extracting a representative point from the reflection level list Dr and outputting coordinate information Dp thereof, and a rotation step determination function 422 for determining a rotation step of a detection line segment St on the basis of the coordinates of the representative point and outputting rotation step information Ds. Further, it functions to have a reflection point counting function 423 for outputting a count result of the reflection points for each rotated detection line segment St as count information Dn, and a reflection point determination function 424 for determining reflection points to be detected as an object in accordance with the count information Dn and outputting them as object detection information De. That is, the representative point extraction function 421 to the reflection point determination function 424 etc. can be read as independent parts such as a representative point extraction unit to a reflection point determination unit.

Next, each function (each unit) will be described in detail with reference to a flowchart of FIG. 2 (FIG. 2A and FIG. 2B). The millimeter wave emitted from the transmission/reception face 7f is reflected by a target 90 (vehicle) located at a distant position and is received by the transmission/reception face 7f as shown in FIG. 3. A signal Se indicating information on the reflection level of the target, which corresponds to the received radio wave, is outputted from the wave device 7, and the target reflection level receiving unit 41 receives it via the communication function unit 5 (step S100). The target reflection level receiving function 411 calculates the reflection level list Dr indicating the reflection level for each coordinate in the angular direction DA and the front-rear direction DL on the basis of the received signal Se, and outputs the result to the target detection unit 42 via the bus 6 (step S110). Note that, in FIG. 3, and FIG. 4 and FIG. 5 used in the following description, it is shown that the reflection level (signal intensity) is higher as the black color is darker.

The reflection level list Dr is output to the representative point extraction function 421 and the reflection point counting function 423 in the target detection unit 42. In the representative point extraction function 421, under the assumption that the target 90 is captured as a point, a threshold value ThC is set using a first setting reference, which is a dynamic threshold value like CFAR or a fixed value to prevent false detection and is similar to that described in the background art. Then, the reflection level is compared with the threshold value Th, and a reflection point to be representative (representative reflection point Pr) for each target 90 is extracted (step S210). Then, coordinate information Dp of the representative reflection point Pr that is extracted is output to the rotation step determination function 422.

When the threshold value ThC set using the first setting reference is used, the detection of the reflection waves from the reflection points near the area corresponding to the representative reflection point Pr of the target, which is the problem to be solved by the present application, is not possible. However, at this stage, since only one reflection point out of the reflection points of the target 90 needs to be extracted by taking advantage of the feature, a threshold value setting method capable of preventing false detection is used under the assumption that the target 90 is captured intentionally by a point. In addition, although only one representative reflection point Pr is shown in the figure for the sake of simplicity, actually, a plurality of representative reflection points Pr exist discretely depending on the number of targets 90 present in the coordinates.

The rotation step determination function 422 determines a rotation step a of the detection line segment St used for the determination according to the distance Lp to the representative reflection point Pr calculated from the coordinate information Dp or a distance (coordinates) in the front-rear direction DL (step S220). Then, the information of the determined rotation step a (rotation step information Ds) is output to the reflection point counting function 423 together with the coordinate information Dp of the representative reflection point Pr. Note that, the processing cost can be reduced by making the rotation step a (rotation movement angle) larger (coarse) as the distance Lp is longer and smaller (fine) as the distance Lp is shorter. For the sake of simplicity, an example in which the arrangement at equal intervals in the range 360° is shown, but the intervals are not necessarily even, and for example, the intervals may be changed in the rear side and the front side with respect to the representative reflection point Pr.

In the reflection point counting function 423, on the basis of the rotation step information Ds and the coordinate information Dp output from the rotation step determination function 422, 360/α pieces of the detection line segments St for the rotational movement around the representative reflection point Pr within the irradiation field (plane) are set. On the basis of the reflection level list Dr, a threshold value is set for each detection line segment St that is set, the number of reflection points (reflection points) exceeding the threshold value is counted for each detection line segment St, and the counted information (count information Dn) is output to the reflection point determination function 424 (step S220).

Specifically, detection line segments St with a predetermined length starting from the representative reflection point Pr are set about the representative reflection point Pr according to the number for 360° movement by the rotation step a. At this time, when a certain detection line segment St exists on the distribution of the reflection level shown in FIG. 4A, the plurality of determination target points such as P1, P2, . . . Pi are set according to the resolution of the wave device 7. Note that the length of the detection line segment St is set to, for example, 4 to 5 m corresponding to the length of a typical vehicle. That is, the reflection point counting function 423 and the rotation step determination function 422 function as a line segment setting function or a line segment setting unit.

Here, a description on the setting of a threshold value for each determination target point will be given for a case where the signal strength at the determination target points on a certain detection line segment St shows a distribution as shown in FIG. 4B. For example, when the dynamic threshold value ThC is set using the above-described first setting reference, owing to the influence by the intensity of the representative reflection point Pr having the highest intensity, it is determined that there is no detection at the reflection points (determination target points) other than the representative reflection point Pr on the detection line segment St. In contrast, at this stage, a second threshold value ThM set using a second setting reference, which is calculated to be a value lower than the threshold value ThC calculated using the first setting reference, is used. For example, a value corrected by subtracting a constant difference ΔTh from the threshold value ThC on the detection line segment St calculated using the first setting reference is adopted as the second threshold value ThM. This processing is executed for each detection line segment St rotationally moved by each rotation step a.

Note that it is preferable that the difference ΔTh when the second threshold value ThM is obtained using the second setting reference should be within the absolute value of the difference between the main lobe and the first side lobe at the representative reflection point Pr, for example. By keeping it within the absolute value, excessive detection of a clutter is suppressed, and a selection based on the number of reflection points at the detection line segment St described later becomes easy. Note that, in this example, the second threshold value ThM is set for each detection line segment St for easy understanding, but this is not a limitation, and the second threshold value ThM may be set for the entire irradiation field.

When the second threshold value ThM is set in this manner, the number of the reflection points exceeding the second threshold value ThM (reflection point number) is counted for each detection line segment St, and detection line segments St to the second place in the number of the reflection points are selected. When the result of the counting is as shown in FIG. 5A, for example, the first place is a detection line segment Stj having four reflection points, and there are two in the second place and they are a detection line segment Stk and a detection line segment Stn that have three reflection points.

However, since the detection line segment St corresponds to a contour line of the target 90 (vehicle) as will be described later, the detection line segment Stk (having a small angle with the first place detection line segment Stj) adjacent to the first place detection line segment Stj is excluded from among the two second detection lines St of the second place. Then, the detection line segment Stj and the detection line segment Stn are selected as line segments in the upper place of the counting.

Then, the reflection points detected on the selected detection line segment Stj and the reflection points detected on the detection line segment Stn are determined as output reflection points indicating the contour of the target 90 (step S230), and output as the object detection information De. On the basis of the output object detection information De, the vehicle control unit 81V can detect the reflection points on the two detection line segments St, which start from the representative reflection point Pr, as the contour of the target 90 and can recognize the shape of the target to determine the type, for example. Therefore, when installed in a vehicle, it can distinguish a vehicle, a pedestrian, an obstacle, or the like, and recognize a distance or a relative speed.

Note that, even when the reflection points on the selected detection line segment St are not continuous, a lacking point may be regarded as a reflection point and output. As the resolution of the wave device 7 is high relative to the size of the target 90 such as a vehicle, the target 90 can be detected as a contour rather than a point. Thus, it is considered that the result corresponds actually to the continuous contour of the target 90.

When the second threshold value ThM lower than the threshold value ThC is used, false detection may occur, the threshold value ThC being set using the first setting reference for the purpose of capturing the target 90 as a point without the false detection. However, in the number of detection points, by selecting the detection line segment St in the top place and the detection line segment St to the top second place excluding the detection line segment St adjacent to the top place, the false detection occurring in a single detection line segment St is to be eliminated as a result. Therefore, it is possible to detect the target 90 without missing the detection and with suppression of the false detection, and even to identify the shape of the target 90.

As described above, in order to detect the contour, it is desirable to set at least about four pieces of detection line segments St for each representative reflection point Pr; that is, the interval set by 90° or less is desirable. This makes it possible to detect, for example, a contour of a four wheeled vehicle that is substantially rectangular in a plan view. Further, although the number of determination target points (resolution) for each detection line segment St depends on the distance Lp, it is assumed to be about 5 points. This makes it possible to appropriately identify the contour of the object (target 90) as an object.

Depending on the resolution or the setting of the detection line segment St described above, there is no detection line segment St corresponding to the second place, and a two-dimensional contour may not be obtained in some cases. For example, these are the cases in which when a two wheeled vehicle or the like having a width on one side smaller than the resolution is captured, and one side of the four wheeled vehicle is captured from the front. However, even in these cases, the determination can be made on the basis of the coordinates, the relative velocity, and the like.

### Embodiment 2

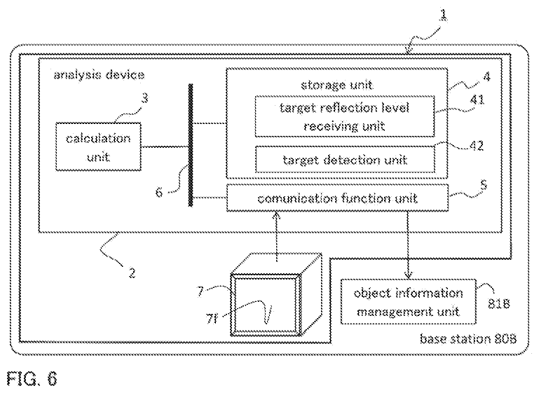

In Embodiment 1, an example in which an object detection system is installed in a vehicle has been described. In Embodiment 2, an example in which an object detection system is installed in a facility such as a base station will be described. FIG. 6 is a block diagram showing an overall configuration of an object detection system according to Embodiment 2. Functions and operations implemented by the object detection system are the same as those of Embodiment 1 except that the subject in which the system is to be installed is different, and the same reference numerals are used for the same parts. Further, FIG. 1B and FIG. 2 to FIG. 5 used in Embodiment 1 are referred to, and descriptions on the similar parts will not be repeated.

As shown in FIG. 6, the object detection system 1 according to Embodiment 2 of the present application includes the wave device 7 and the analysis device 2 for analyzing a position and distance of a target based on signals from the wave device 7 and is provided in the base station 80B. The base station 80B may be, for example, a roadside unit, a center facility or the like. In this case, for example, a high-performance radar (wave device 7) that cannot be installed in a moving body is installed, and analysis by a high-performance arithmetic device is possible. As a result, for example, an object information management unit 81B can perform high-precision analysis such as identifying a contour of an aircraft or a flying object moving at a high speed and determining the type thereof. Furthermore, it is also possible to identify information on vehicles and the like from a broad overview on the ground.

### Embodiment 3

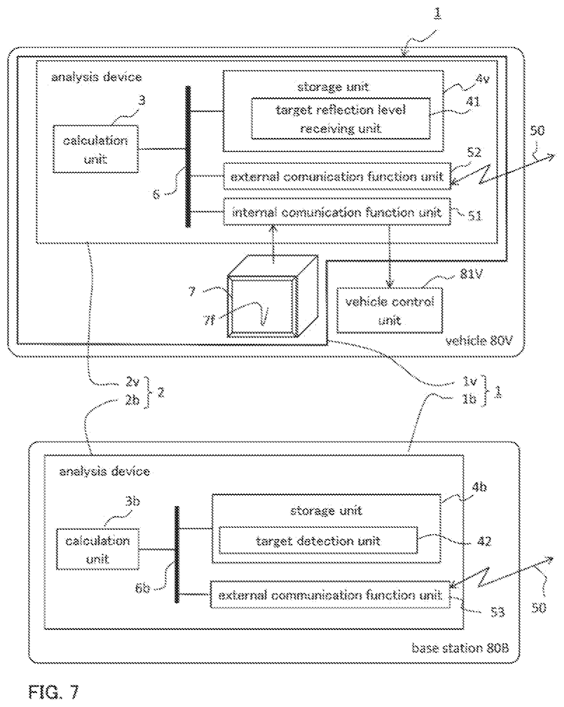

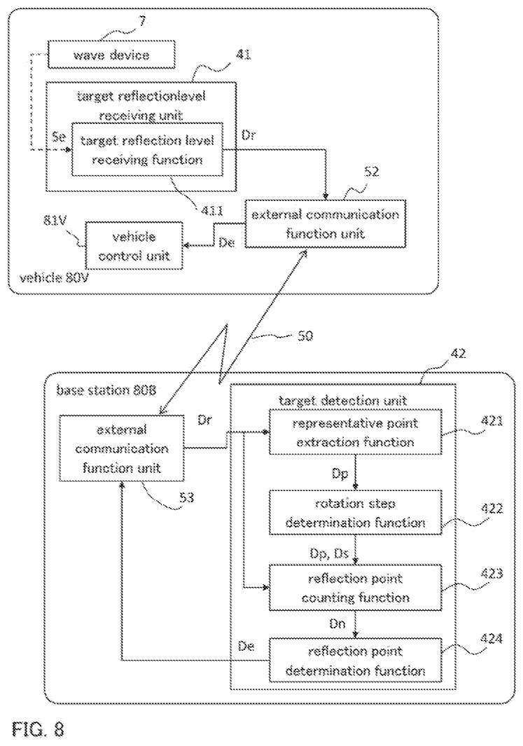

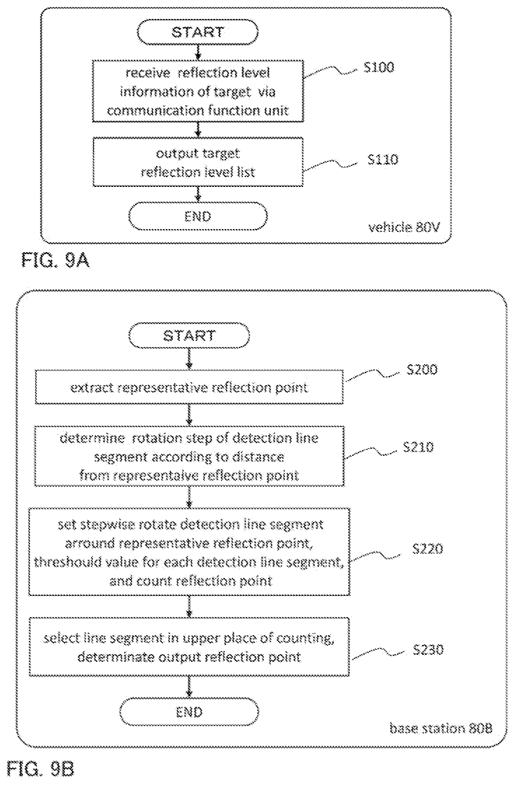

In Embodiment 1 and Embodiment 2, an example in which the object detection systems is collectively installed at one location has been described. In Embodiment 3, an example in which an object detection system is installed separately in two facilities such as a vehicle and a base station will be described. FIG. 7 to FIG. 9 are diagrams for explaining the object detection system or an object detection method according to Embodiment 3, FIG. 7 is a block diagram showing an overall configuration of the object detection system, FIG. 8 is a block diagram showing a detailed configuration of part of an analysis device for determining a shape of a target, and FIG. 9 includes a flowchart showing an operation of a target reflection level receiving unit installed in the vehicle (FIG. 9A) and a flowchart showing an operation of a target detection unit installed in the base station (FIG. 9B).

The functions implemented by the object detection system and the operations for detecting a target are the same as those in Embodiment 1 except that the object detection system is installed separately into a plurality of subjects in which the system is to be installed and communication functions between the separated subjects are added, and the same reference numerals are used for the same parts. Further, FIG. 3 to FIG. 5 used in Embodiment 1 are referred to, and descriptions on the similar parts will not be repeated.

As shown in FIG. 7, the object detection system 1 according to Embodiment 3 of the present application also includes the wave device 7 installed in the vehicle 80V, and the analysis devices 2 that are installed separately on the vehicle 80V and the base station 80B and analyze a position and distance of a target on the basis of signals from the wave device 7. Among the analysis devices 2, the calculation unit 3v installed in the vehicle 80V functions as the target reflection level receiving unit 41 stored in the storage unit 4v of an analysis device 2v and the calculation unit 3b installed in the base station 80B functions as the target detection unit 42 stored in a storage unit 4b of an analysis device 2b.

The analysis device 2v is provided with an internal communication function unit 51 for communicating with the wave device 7 and the vehicle control unit 81V in the vehicle 80V, and an external communication function unit 52 for communicating with the analysis device 2b in the base station 80B via, for example, a communication path 50 by wireless communication.

Further, the analysis device 2b is provided with an external communication function unit 53 for the communication via the communication path 50, corresponding to the external communication function unit 52 formed in the analysis device 2v of the vehicle 80V. The analysis device 2v is provided with a bus 6v for connecting the calculation unit 3v, the storage unit 4v, the internal communication function unit 51, and the external communication function unit 52 so as to be able to communicate bidirectionally, and the analysis device 2b is provided with a bus 6b for connecting the calculation unit 3b, the storage unit 4b, and the external communication function unit 53 so as to be able to communicate bidirectionally.

As a result, in the vehicle 80V the target reflection level receiving function 411 stored in the storage unit 4v receives the signal Se output from the wave device 7 as shown in FIG. 8, and causes the calculation unit 3v to function as the target reflection level receiving unit 41 for calculating the reflection level list Dr. The calculated reflection level list Dr is transmitted from the external communication function unit 52 to the base station 80B via the communication path 50.

On the other hand, in the base station 80B, the representative point extraction function 421 or the like stored in the storage unit 4b detects a target from the reflection level list Dr and causes the calculation unit 3b to function as the target detection unit 42 for calculating the object detection information De such as a distance, a position, and a contour shape of the target. Then, the calculated object detection information De is transmitted from the external communication function unit 53 toward the vehicle 80V via the communication path 50 and is output to the vehicle control unit 81V.

Thus, the object detection system 1 is separated into the vehicle 80V and the base station 80B, and as shown in FIG. 9 (FIG. 9A and FIG. 9B), steps S100 to S110 are to be executed in the vehicle 80V, and steps S200 to S230 are to be executed in the base station 80B. Even so, it is possible to identify the shape of the target 90 detected by the wave device 7 and determine the type. In particular, the base station 80B is provided with the target detection unit 42 in which complicated calculation processing is involved, so that it is possible to perform high-speed calculations using a high-performance processor, a storage device, or the like. Note that the identification of the object type is performed in the vehicle control unit 81V installed on the vehicle 80V but this is not a limitation, and it may be performed in the base station 80B.

It is also possible to configure the object detection system 1 such that a plurality of vehicles 80V are connected to one base station 80B, and in this case, it is also possible to merge information from a plurality of vehicles 80V to obtain more accurate information. For example, the identification information on a specific target corresponding to a contour may be accumulated, and information such as a type of a vehicle may be added.

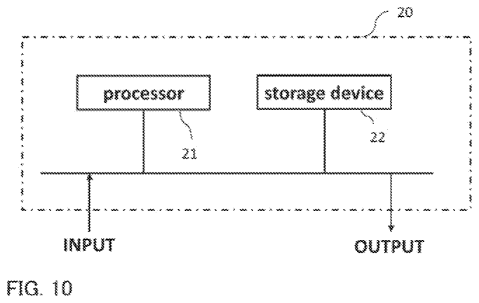

Note that, as described above, the analysis device 2 (or analysis device 2b, analysis device 2v) constituting the object detection system 1 according to each embodiment can be represented by a configuration of one piece of hardware 20 including a processor 21 and a storage device 22 as shown in FIG. 10. Although not shown, the storage device 22 corresponding to the storage unit 4 includes the volatile storage device such as the random access memory and the non-volatile auxiliary storage device such as the flash memory.

Further, the auxiliary storage device of the hard disk may be provided in place of the flash memory. The processor 21 corresponding to the calculation unit 3 executes a program input from the storage device 22. In this case, the program is input from the auxiliary storage device to the processor 21 via the volatile storage device. Further, the processor 21 may output data such as calculation results to the volatile storage device of the storage device 22 or may store data in the auxiliary storage device via the volatile storage device.

Note that, although various exemplary embodiments and examples are described in the present application, various features, aspects, and functions described in the embodiments are not inherent in a particular embodiment and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with another component are included.

For example, a configuration may be such that the information captured and analyzed by the wave device 7 installed in the base station 80B may be transmitted to a plurality of vehicles 80V. In this way, detailed analysis data can be utilized by a plurality of vehicles 80V. The length of the detection line segment St is preferably 3 to 6 m (preferably 4 to 5 m) when a vehicle is assumed to be the detection target but is not limited to this. Depending on the size of the detection target and the resolution of the wave device 7, for example, the reflection point may be appropriately determined to be four or more within the detection line segment St.

As described above, according to the object detection system 1 of Embodiment 1, the object detection system 1 is configured to include the wave device 7 for radiating a wave and receiving a reflected wave, the reflection level calculation unit (target reflection level receiving function 411) for calculating the reflection level (reflection level list Dr) for each of the coordinate points within the radiation field from the signal Se output from the wave device 7, the representative point extraction unit (representative point extraction function 421) for extracting the coordinate point indicating the reflection level higher than the threshold value ThC as the representative reflection point Pr of an object (target 90) that exists in the irradiation field by comparing the reflection level for each of the coordinate points with the threshold value ThC set by using the first setting reference, the line segment setting unit (rotation step determination function 422, reflection point counting function 423) for setting the plurality of line segments (detection line segments St) of the same length that extend from the representative reflection point Pr and are arranged at the intervals in the circumferential direction within the irradiation field about the representative reflection point Pr as the center, the reflection point counting unit (reflection point counting function 423) for counting a coordinate point indicating the reflection level higher than the second threshold value ThM as the reflection point in each of the plurality of line segments (detection line segments St) by using the second threshold value ThM set using the second setting reference by which a value lower than the threshold value ThC is calculated, and the reflection point determination unit (reflection point determination function 424) for determining the reflection points counted in the line segments (detection line segments St) to the top second place in which the number of the counted reflection points is large among the plurality of line segments (detection line segments St), as the reflection points from the object (target 90). Therefore, the shape of the target can be determined by detecting the arrangement of the reflection points forming the contour of the facing portions of the target 90.

In particular, if the line segment setting unit (rotation step determination function 422 or the reflection point counting function 423) is configured so as to set the plurality of line segments (detection line segments St) within a range of 3 to 6 m in length, it is possible to reliably capture the outline of the vehicle and enhance the driving assistance.

Further, if the line segment setting unit (rotation step determination function 422) arranges the plurality of line segments (detection line segments St) at regular intervals (rotation step a) of 90° or less, the contour of the vehicle can be more accurately captured.

Or, if the line segment setting unit (rotation step determination function 422) is configured such that the interval (rotation step a) is narrowed as the distance to the representative reflection point Pr is shorter, analysis can be performed with an optimum calculation amount in accordance with the characteristics of the radar, for example.

When the CFAR method or the fixed value setting is used as the first setting reference, the representative reflection point Pr can be extracted without being affected by the clutter, or the representative reflection point Pr can be extracted without increasing the calculation amount.

In the second setting reference, when the second threshold value ThM is set within a range in which the difference ΔTh from the threshold value ThC is equal to or smaller than the absolute value of the difference between the main lobe and the first side lobe at the representative reflection point Pr, the excessive detection of the clutter is suppressed, and the selection based on the number of reflection points at the detection line segment St becomes easy.

As described above, according to the object detection method of Embodiment 1, the object detection method is configured to include the reflection level calculation step (step S100 to step S110) for receiving a reflected wave when a wave is radiated and calculating the reflection level (reflection level list Dr) for each of the coordinate points within the irradiation field, the representative point extraction step (step S200) for extracting the coordinate point indicating a reflection level higher than the threshold ThC as the representative reflection point Pr of an object (target 90) within the irradiation field by comparing the reflection level for each of the coordinate points with the threshold ThC set by the first setting standard, the line segment setting step (step S210 to step S220) for setting the plurality of line segments (detection line segments St) of the same length that extend from the representative reflection point Pr and are arranged at the intervals in the circumferential direction within the irradiation field about the representative reflection point Pr as the center, the reflection point counting step (step S220) for counting the coordinate point indicating a reflection level higher than the second threshold value ThM as the reflection point for each of the plurality of line segments (detection line segments St) by using the second threshold value ThM set using the second setting reference by which a value lower than the threshold value ThC is calculated, and the reflection point determination step (step S230) for determining the reflection points counted in the line segments (detection line segments St) to the top second place, in which the number of the counted reflection points is large among the plurality of the line segments (detection line segments St), as the reflection points from the object (target 90).

Therefore, the shape of the target can be determined by detecting the arrangement of the reflection points forming the contour of the facing portions of the target 90.

In the line segment setting step (step S210), if the interval (rotation step a) is narrowed as the distance between the representative reflection points Pr is shorter, analysis can be performed with an optimum calculation amount according to the characteristics of the radar, for example.

If the CFAR method or the fixed value setting is used as the first setting reference, the representative reflection point Pr can be extracted without being affected by the clutter, or the representative reflection point Pr can be extracted without increasing the calculation amount.

In the second setting standard, if the second threshold value ThM is set within a range in which the difference ΔTh from the threshold value ThC is equal to or smaller than the absolute value of the difference between the main lobe and the first side lobe at the representative reflection point Pr, the excessive detection of clutter is suppressed, and selection based on the number of reflection points at the detection line segment St becomes easy.

### DESCRIPTION OF REFERENCE NUMERALS AND SIGNS

1: object detection system, 2: analysis device, 3: calculation unit, 4: storage unit, 41: target reflection level receiving unit, 411: target reflection level receiving function (reflection level calculation unit), 42: target detection unit, 421: representative point extraction function (representative point extraction unit), 422: rotation step determination function (line segment setting unit), 423: reflection point counting function (line segment setting unit), 424: reflection point determination function (reflection point determination unit), 5: communication function unit, 7: wave device, 7f: transmission/reception face, 80B: base station, 80V: vehicle, Pr: representative reflection point, St: detection line segment, α: rotation step (interval), ThC: threshold value, ThM: second threshold value, ΔTh: difference.

1.-6. (canceled)

7. An object detection method, comprising:
a reflection level calculation step of receiving a reflected wave when a wave is radiated and calculating a reflection level for each of coordinate points within an irradiation field;
a representative point extraction step of extracting a coordinate point indicating a reflection level higher than a threshold value as a representative reflection point of an object that exists within the irradiation field by comparing a reflection level for each of the coordinate points with the threshold value set using a first setting reference;
a line segment setting step of setting a plurality of line segments of the same length that extend from the representative reflection point and are arranged at intervals in a circumferential direction within the irradiation field about the representative reflection point as a center;
a reflection point counting step of counting a coordinate point indicating a reflection level higher than a second threshold value as a reflection point in each of the plurality of line segments by using the second threshold value set using a second setting reference by which a value lower than the threshold value is calculated; and
a reflection point determination step of determining a reflection point counted in the line segments to a top second place in which the number of the counted reflection points is large among the plurality of line segments, as a reflection point from the object.

8. The object detection method according to claim 7, wherein, in the line segment setting step, the interval is narrowed as a distance to the representative reflection point is shorter.

9. The object detection method according to claim 7, wherein a CFAR method or a fixed value setting is used as the first setting reference.

10. The object detection method according to claim 7, wherein, in the second setting reference, the second threshold value is set in a range in which a difference from the threshold value is equal to or smaller than an absolute value of a difference between a main lobe and a first side lobe at the representative reflection point.

11. An object detection system, comprising:
a wave device to radiate a wave and receive a reflected wave;
a reflection level calculator to calculate a reflection level for each of coordinate points within an irradiation field from a signal output from the wave device;
a representative point extraction circuitry to extract a coordinate point indicating a reflection level higher than a threshold value as a representative reflection point of an object that exists within the irradiation field by comparing a reflection level for each of the coordinate points with the threshold value set by using a first setting reference;
a line segment setting circuitry to set a plurality of line segments of the same length that extend from the representative reflection point and are arranged at intervals in a circumferential direction within the irradiation field about the representative reflection point as a center;
a reflection point counter to count a coordinate point indicating a reflection level higher than a second threshold value as a reflection point in each of the plurality of line segments by using the second threshold value set using a second setting reference by which a value lower than the threshold value is calculated; and
a reflection point determinator to determine a reflection point counted in the line segments to a top second place in which the number of the counted reflection points is large among the plurality of line segments, as a reflection point from the object.

12. The object detection system according to claim 11, wherein the line segment setting circuitry sets the plurality of line segments within a range from 3 to 6 m in length.

13. The object detection system according to claim 11, wherein the line segment setting circuitry arranges the plurality of line segments at regular intervals of 90° or less.

14. The object detection system according to claim 11, wherein the line segment setting circuitry narrows the interval as a distance to the representative reflection point is shorter.

15. The object detection system according to claim 12, wherein the line segment setting circuitry narrows the interval as a distance to the representative reflection point is shorter.

16. The object detection system according to claim 13, wherein the line segment setting circuitry narrows the interval as a distance to the representative reflection point is shorter.

17. The object detection system according to claim 11, wherein a CFAR method or a fixed value setting is used as the first setting reference.

18. The object detection system according to claim 12, wherein a CFAR method or a fixed value setting is used as the first setting reference.

19. The object detection system according to claim 13, wherein a CFAR method or a fixed value setting is used as the first setting reference.

20. The object detection system according to claim 14, wherein a CFAR method or a fixed value setting is used as the first setting reference.

21. The object detection system according to claim 11, wherein, in the second setting reference, the second threshold value is set in a range in which a difference from the threshold value is equal to or smaller than an absolute value of a difference between a main lobe and a first side lobe at the representative reflection point.

22. The object detection system according to claim 12, wherein, in the second setting reference, the second threshold value is set in a range in which a difference from the threshold value is equal to or smaller than an absolute value of a difference between a main lobe and a first side lobe at the representative reflection point.

23. The object detection system according to claim 13, wherein, in the second setting reference, the second threshold value is set in a range in which a difference from the threshold value is equal to or smaller than an absolute value of a difference between a main lobe and a first side lobe at the representative reflection point.

24. The object detection system according to claim 14, wherein, in the second setting reference, the second threshold value is set in a range in which a difference from the threshold value is equal to or smaller than an absolute value of a difference between a main lobe and a first side lobe at the representative reflection point.

25. The object detection system according to claim 17, wherein, in the second setting reference, the second threshold value is set in a range in which a difference from the threshold value is equal to or smaller than an absolute value of a difference between a main lobe and a first side lobe at the representative reflection point.
